(19) United States
(12) Patent Application Publication
(10) Pub. No.: US 2011/0001330 A1
(43) Pub. Date: Jan. 6, 2011

(54) COWLINGS FOR GOLF CARTS AND OTHER VEHICLES FOR CONCEALING ENCLOSURES AND OTHER ACCESSORIES

(76) Inventor: Paul J. Hirneise, Gainesville, FL (US)

Correspondence Address: EDWARD M. LIVINGSTON, PA, 963 TRAIL TERRACE DRIVE, NAPLES, FL, 34103, US

(21) Appl. No.: 12/496,798

(22) Filed: Jul. 2, 2009

(51) Int. Cl. B60J 1/00

(52) U.S. Cl. 296/77.1

(57) ABSTRACT

A cowling enclosure framework (2) having cowlings (6, 7 & 17) that may be mounted to an upper structure (3) of a vehicle, such as a golf cart (1). The cowlings provide protection from adverse weather and also provide an area for concealing the flaps of a flexible enclosure (8) of the enclosure and/or a cargo cover (9) while retracted and not in use. A user may simply roll or fold flaps and/or a cargo cover into the storage space created by the cowlings. An added benefit of the cowlings is that it they extend the area of the roof (4), thereby providing extra protection to occupants of the vehicle from the sun and rain.

### BACKGROUND OF THE INVENTION

This invention relates to golf carts and other vehicles and more particularly, cowlings for golf carts and other vehicles that are mounted to an upper structure of a golf cart or other vehicles to provide a streamlined storage area for concealing enclosures and other accessories, such as golf bag covers and windshields, while retracted and not in use.

People who use golf carts, such as golfers, and even more particularly, retirees who use golf carts for local transportation in and near their communities, desire to have enclosures, generally made of a combination of berry fabric and vinyl, on the golf cart to protect them from adverse weather, such as cold, wind and rain, or from insects. Currently, enclosures are made solely out of flexible materials, such as plastic vinyl and/or canvas, that attaches to the upper structure of a golf cart. These enclosures are either rolled down around the upper structure of a golf cart while in use or slid horizontally along the perimeter of the roof to the back of the golf cart while not in use. One problem with these enclosures is that they are bulky, unattractive and attract mold and mildew. An additional problem is that they are difficult to roll up and down and sometimes require a user to be outside of the golf cart in order to roll the enclosure down and secure it in place, thereby defeating the purpose of the enclosure in cases where a rain storm suddenly comes upon a user and the enclosure is not already in an extended and closed position.

Therefore, a need exists for a device that conceals enclosures and other accessories that is aesthetically pleasing when the enclosures and accessories are retracted and not in use.

The relevant prior art includes the following references:

| Pat. No. | | |
|---|---|---|
| (U.S. unless stated otherwise) | Inventor | Issue/Publication Date |
| 5,788,317 | Nation | Aug. 04, 1998 |
| 5,588,690 | Showalter | Dec. 31, 1996 |
| 5,195,797 | Hobbs | Mar. 23, 1993 |
| 5,259,656 | Carroll | Nov. 09, 1993 |
| 4,773,694 | Gerber | Sep. 27, 1988 |
| 1,679,886 | Wright | Aug. 07, 1928 |
| 1,444,413 | Collins | Feb. 06, 1923 |
| 879,218 | Tickerhoof | Feb. 18, 1908 |

### SUMMARY OF THE INVENTION

The primary object of the present invention is to provide cowlings for golf carts and other vehicles that conceal enclosures and other accessories when not in use.

Another object of the present invention is to provide cowlings for golf carts and other vehicles for concealing enclosures and other accessories that are aesthetically pleasing.

A further object of the present invention is to provide cowlings for golf carts and other vehicles for concealing enclosures and other accessories that protects occupants from adverse weather.

An even further object of the present invention is to provide cowlings for golfcarts and other vehicles for concealing enclosures and other accessories that conceals useful components, such as solar panel, head lights, tail lights, mirrors and more.

The present invention fulfills the above and other objects by providing cowlings which may be mounted to an upperstructure of a vehicle, such as a golf cart. The cowlings provide an area for concealing the rest of the enclosure while not in use and in an open and retracted position. Optional cowlings on the back of the golf cart store and conceal covers for golf club bags. Front cowlings may also conceal windshields when not in use. An added benefit of the cowlings is that it they extend the area of the roof, thereby providing extra protection to occupants of the golf cart from the sun, rain and other weateven when the enclosure is in a retracted and open position.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side plan view of a golf cart showing the cowling enclosure framework of the present invention with side enclosures and cargo cover in use;

FIG. 2 is a side plan view of a golf cart having the cowling enclosure framework of the present invention with side enclosures and cargo cover in a stored and concealed position;

FIG. 3 is a rear view from the interior of a golf cart looking outward of a side cab cowling having a cab flap of an enclosure in a vertical retracted open position attached thereto;

FIG. 4 is a rear view from the interior of a golf cart looking outward of a side cab cowling having a cab flap of an enclosure in a horizontal rolled up position attached thereto;

FIG. 5 is a side plan view of a side cargo cowling covering the cargo area of a golf cart and mounted to an upper structure of the golf cart; and

FIG. 6 is a front view of a golf cart having front cab cowlings of the present invention mounted thereto.

### DESCRIPTION OF THE PREFERRED EMBODIMENTS

For purposes of describing the preferred embodiment, the terminology used in reference to the numbered accessories in the drawings is as follows:

| | |
|---|---|
| 1. | golf cart |
| 2. | cowling enclosure framework |
| 3. | upper structure |
| 4. | roof |
| 5. | vertical support |
| 6. | side cab cowling |
| 7. | side cargo cowling |
| 8. | cab flap |
| 9. | cargo cover |
| 10. | opaque section |
| 11. | clear section |
| 12. | attachment means |
| 13. | strap |
| 14. | guide means |
| 15. | top cargo cowling |
| 16. | internal frame |
| 17. | front cab cowling |
| 18. | windshield |
| 19. | pivot point |

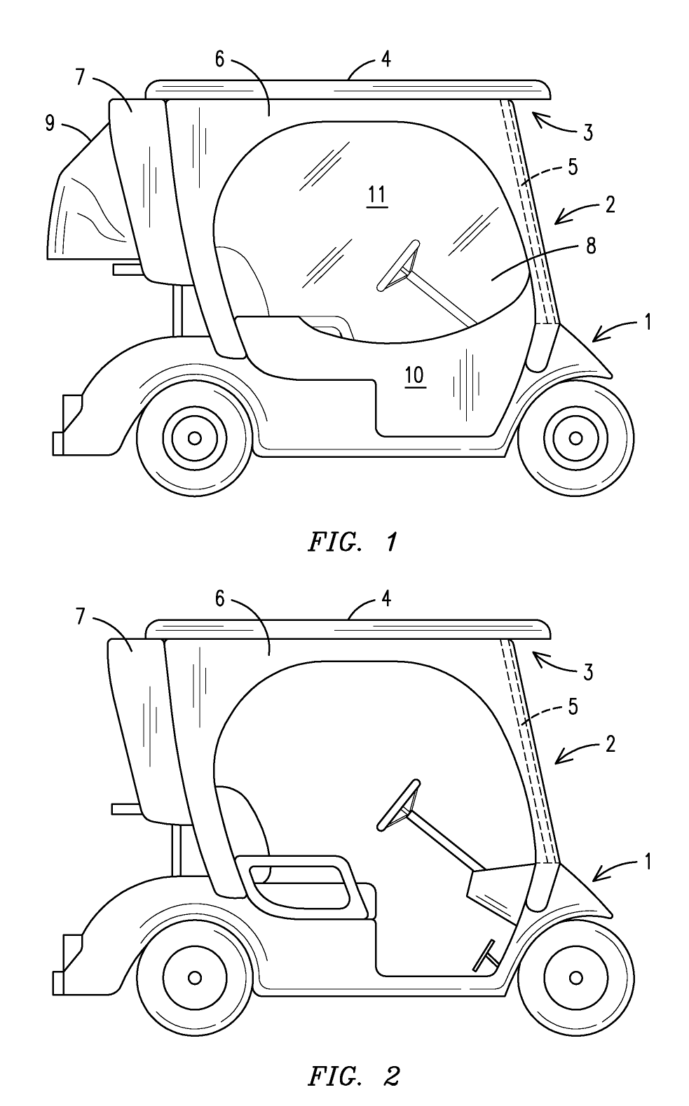

With reference to FIG. 1, a side plan view of a golf cart 1 showing the cowling enclosure framework (“cowling”) 2 of the present invention with side enclosures 8 and cargo cover 9 in use is shown. The cowling 2 comprises side cab cowlings 6 and side cargo cowlings 7, which are preferably made of a hard material, such as plastic. The side cab cowlings 6 and side cargo cowlings 7 are attached to an upper structure 3 of the golf cart 1, which comprises a roof 4 and vertical supports 5. The side cab cowlings 6 provide additional coverage around the perimeter of the upper structure 3 for partial protection from adverse weather conditions. A side enclosure 8, which is preferably made of a flexible material, such as plastic vinyl and/or canvas, allows a user to close the sides of the golf cart 1 for full protection from adverse weather conditions. The side enclosure 8 has an opaque section 10 for privacy and a clear section 11. The side cargo cowlings 7 and a cargo cover 9, shown here in an extended and closed position, protect cargo, such as golf clubs, from adverse weather.

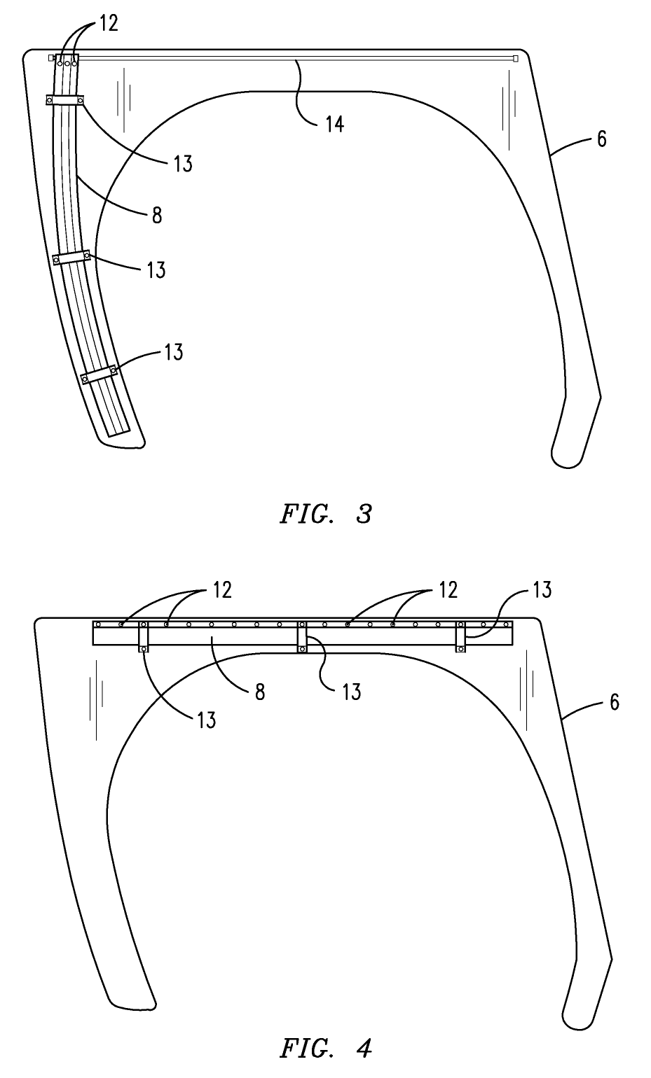

Referring now to FIG. 2, a side plan view of a golf cart 1 having the cowling enclosure framework (“cowling”) 2 of the present invention with side enclosures 8 and cargo cover 9 in a stored and concealed position is shown. The enclosure 2 comprises side cab cowlings 6 and side cargo cowlings 7, which are preferably made of a hard material, such as plastic. The side cab cowlings 6 and side cargo cowlings 7 are attached to an upper structure 3, which comprises a roof 4 and vertical supports 5. The side cab cowlings 6 provide additional coverage around the perimeter of the upper structure 3 for partial protection from adverse weather conditions. A side enclosure 8, which is preferably made of a flexible material, such as plastic vinyl or canvas, is in a retracted and stored position behind the side cab cowling 6, which conceals the retracted and stored side enclosure 8 from view, as shown further in FIGS. 3 and 4. A cargo cover 9 is in a retracted and open position behind the side cargo cowling 7 which conceals the open and cargo cover 9 from view, as shown further in FIG. 5.

Referring now to FIG. 3, a rear view from the interior of a golf cart 1 looking outward of a side cab cowling 6 having a side enclosure 8 in a vertical retracted open position attached thereto is shown. The side enclosure 8, which is preferably made of a flexible material, such as a plastic vinyl or canvas, is in a retracted and open position concealed by the side aft portion of the side cab cowling 6. The side enclosure 8 may be attached to the side cab cowling 6 via attachment means 12, such as clips, grommets, zippers, etc., and a guide means 14, which allows a user to slide the cab flap 8 back and forth from a extended and closed position to a retracted and open position. The side cab cowling 6 conceals the retracted side enclosure 8 from view. Straps 13 allow a user to secure the side enclosure 8 to the side cab cowling 6 while the side enclosure 8 is in a retracted and open position.

Referring now to FIG. 4, a rear view from the interior of a golf cart 1 looking outward of a side cab cowling 6 having a side enclosure 8 of an enclosure in a horizontal rolled up position attached thereto is shown. The side enclosure 8, which is preferably made of a flexible material, such as a plastic vinyl or canvas, is in a retracted and stored position. The cab flap 8 may be attached to the side cab cowling 6 via attachment means 12, such as clips, grommets, zippers, etc. The side enclosure 8 may be rolled from an extended and closed position to a retracted and open position. The side cab cowling 6 conceals the retracted cab flap 8 from view. Straps 13 allow a user to secure the side enclosure 8 to the side cowling 6 while the side enclosure 8 is in a stored position.

Referring now to FIG. 5, a side plan view of a side cargo cowling 7 covering the cargo area of a golf cart 1 and mounted to an upper structure 3 of the golf cart 1 is shown. The cowling enclosure framework 2 comprises side cargo cowlings 7 mounted to vertical supports 5 of an upper structure 3. A top cargo cowling 15 is attached to the upper structure 3 of the golf cart 1. The top cargo cowling 15 and side cargo cowlings 7 are preferably made of a hard material, such as plastic. A cargo cover 9, which is preferably made of a flexible material, such as canvas or plastic vinyl or, is attached to the upper structure 3 via an attachment means 12, such as clips, grommets, zippers, etc. The cargo cover 9 is stretched across a folding internal frame 16. The folding internal frame 16 is attached at pivot points 19 to the side cargo cowlings 7 so that the cargo cover 9 may be folded upward into a retracted and open position or downward into in an extended and closed position.

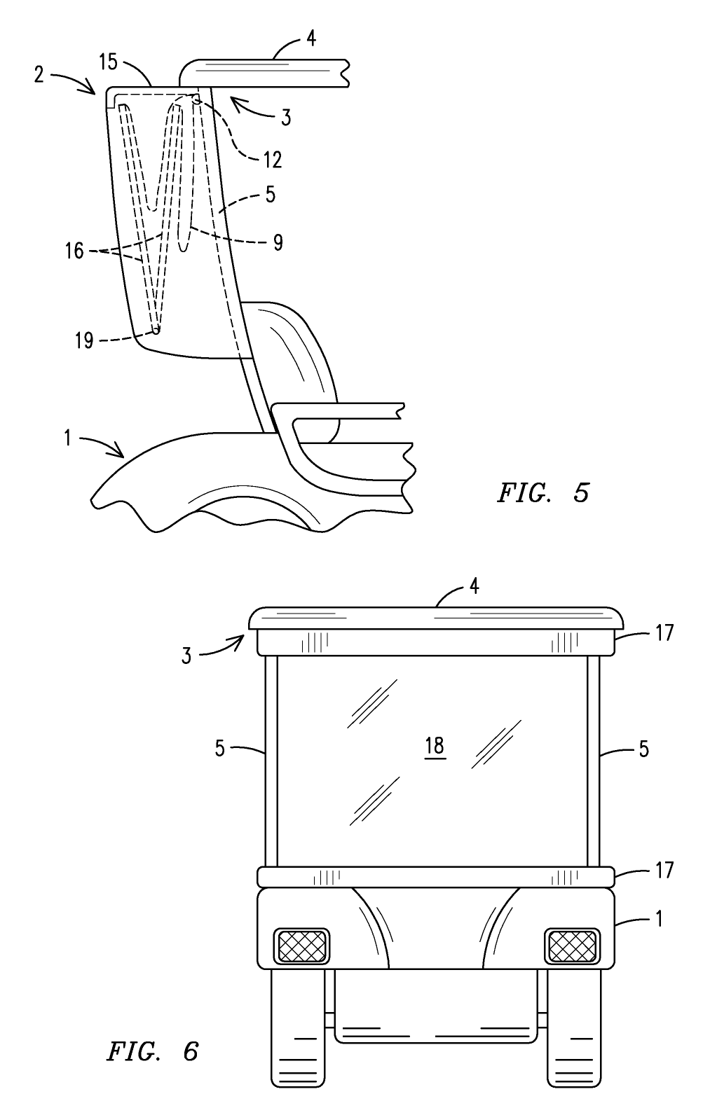

Now referring to FIG. 6, a front view of a golf cart 1 having front cab cowlings 17 of the present invention mounted thereto is shown. The front cab cowlings 17 are mounted between two vertical supports 5 of the upper structure 3. The front cab cowlings 17 provide additional support to the cowling enclosure framework 2 and cover any gaps between a windshield 18 and the golf cart 1 or the windshield and the roof 4. In addition, the front cowlings 17 conceal the windshield 18 while the windshield 18 is in a retracted and stored position.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. An enclosure cowling for golf carts and other vehicles comprising:
an upper structure; and
at least one cowling mounted to the upper structure.

2. The enclosure cowling for golf carts and other vehicles of claim 1 wherein:
the at least one cowling further comprises at least two side cab cowlings mounted to the upper structure.

3. The enclosure cowling for golf carts and other vehicles of claim 1 further comprising:
at least one flap attached to the at least one cowling; and
a guide means that allows a user to slide the at least one flap back and forth from an extended position to a retracted position concealed behind the at least one cowling.

4. The enclosure cowling for golf carts and other vehicles of claim 1 further comprising:
at least one flap attached to the at least one cowling that may be rolled from an extended position into a retracted position concealed behind the at least one cowling.

5. The enclosure cowling for golf carts and other vehicles of claim 2 further comprising:
at least one flap attached to the at least one cowling; and
a guide means that allows a user to slide the at least one flap back and forth from an extended position to a retracted position concealed behind the at least one cowling.

6. The enclosure cowling for golf carts and other vehicles of claim 2 further comprising:
at least one flap attached to the at least one cowling that may be rolled from an extended position to a retracted position concealed behind the at least one cowling.

7. The enclosure cowling for golf carts and other vehicles of claim 3 further comprising:
at least one strap for securing the at least one flap in a retracted position behind the at least one cowling.

8. The enclosure cowling for golf carts and other vehicles of claim 4 further comprising:
at least one strap for securing the at least one flap in a retracted position behind the at least one cowling.

9. The enclosure cowling for golf carts and other vehicles of claim 5 further comprising:
at least one strap for securing the at least one flap in a retracted position behind the at least one cowling.

10. The enclosure cowling for golf carts and other vehicles of claim 6 further comprising:
at least one strap for securing the at least one flap in a retracted position behind the at least one cowling.

11. The enclosure cowling for golf carts and other vehicles of claim 1 wherein:
the at least one cowling further comprises at least two side cargo cowlings mounted to the upper structure.

12. The enclosure cowling for golf carts and other vehicles of claim 2 wherein:
the at least one cowling further comprises at least two side cargo cowlings mounted to the upper structure.

13. The enclosure cowling for golf carts and other vehicles of claim 11 further comprising:
at least one top cargo cowling mounted to the upper structure.

14. The enclosure cowling for golf carts and other vehicles of claim 12 further comprising:
at least one top cargo cowling mounted to the upper structure.

15. The enclosure cowling for golf carts and other vehicles of claim 1 further comprising:
at least one cargo cover attached to the upper structure; and
a folding frame that supports the at least one cargo cover and allows a user to fold the cargo cover from an extended position to a retracted position concealed behind the at least one cowling.

16. The enclosure cowling for golf carts and other vehicles of claim 11 further comprising:
at least one cargo cover attached to the upper structure; and
a folding frame that supports the at least one cargo cover and allows a user to fold the cargo cover from an extended position to a retracted position concealed behind the at least one cowling.

17. The enclosure cowling for golf carts and other vehicles of claim 12 further comprising:
at least one cargo cover attached to the upper structure; and
a folding frame that supports the at least one cargo cover and allows a user to fold the cargo cover from an extended position to a retracted position concealed behind the at least one cowling.

18. The enclosure cowling for golf carts and other vehicles of claim 13 further comprising:
at least one cargo cover attached to the upper structure; and
a folding frame that supports the at least one cargo cover and allows a user to fold the cargo cover from an extended position to a retracted position concealed behind the at least one cowling.

19. The enclosure cowling for golf carts and other vehicles of claim 14 further comprising:
at least one cargo cover attached to the upper structure; and
a folding frame that supports the at least one cargo cover and allows a user to fold the cargo cover from an extended position to a retracted position concealed behind the at least one cowling.

20. The enclosure cowling for golf carts and other vehicles of claim 1 wherein:
the at least one cowling further comprises at least one front cab cowling mounted to the upper structure.

21. The enclosure cowling for golf carts and other vehicles of claim 2 wherein:
the at least one cowling further comprises at least one front cab cowling mounted to the upper structure.

22. The enclosure cowling for golf carts and other vehicles of claim 11 wherein:
the at least one cowling further comprises at least one front cab cowling mounted to the upper structure.
